(19) United States
(12) Patent Application Publication
(10) Pub. No.: US 2025/0236260 A1
(43) Pub. Date: Jul. 24, 2025

(54) NEW ENERGY AUTOMOBILE WINDSHIELD WIPER CONTROL METHOD, ELECTRONIC EQUIPMENT AND STORAGE MEDIUM

(71) Applicant: Shanghai Jihan Electronic Technology Co., Ltd., Shanghai (CN)

(72) Inventors: Lingbo QIN, Shanghai (CN); Pan ZHOU, Shanghai (CN)

(73) Assignee: Shanghai Jihan Electronic Technology Co., Ltd., Shanghai (CN)

(21) Appl. No.: 19/012,612

(22) Filed: Jan. 7, 2025

(30) Foreign Application Priority Data
Jan. 19, 2024 (CN) 202410081345.8

(51) Int. Cl. B60S 1/08

(52) U.S. Cl. CPC B60S 1/0818; B60S 1/0896

(57) ABSTRACT

A windshield wiper control method of a new energy automobile includes the following steps: when a windshield wiper controller is in a first wiping state, if the windshield wiper controller receives a high-speed gear signal sent by a windshield wiper control terminal or receives a rainstorm instruction sent by a central control display screen, the windshield wiper controller entering a rainstorm mode; when the windshield wiper controller is in a second wiping state, if the windshield wiper controller receives a rainstorm instruction sent by the central control display screen, the windshield wiper controller entering a rainstorm mode; wherein the rainstorm mode is used for indicating the windshield wiper controller to control the windshield wiper windshield wiper, the key area of the automobile windshield is wiped at the safety frequency.

### CROSS-REFERENCE TO RELATED APPLICATIONS

This application claims priority to Chinese Patent Application No. 202410081345.8, filed on Jan. 19, 2024, the content of which is incorporated herein by reference in its entirety.

### TECHNICAL FIELD

The disclosure relates to the technical field of new energy automobile, in particular to a new energy automobile windshield wiper control method, an electronic equipment and a storage medium.

### BACKGROUND ART

When the automobile runs in a heavy rain environment, the windows of the automobile can be covered by rainwater too much, so that the sight line of a driver is blocked, and the driving safety of the automobile is threatened.

At present, a windshield wiper controller is usually adopted to control a windshield wiper to carry out high-frequency wiping on an automobile windshield; however, the inventor found that, once the automobile runs in a heavy rain environment, high-frequency wiping of the automobile window cannot timely sweep rainwater covered on the automobile windshield, and if the wiping frequency of the windshield wiper is further increased, the windshield wiper is easily damaged.

### SUMMARY

The application aims to provide a new energy automobile windshield wiper control method, an electronic equipment and a storage medium, which is used to solve the problem that in the prior art, when the automobile runs in a heavy rain environment, high-frequency wiping of an automobile window cannot timely sweep rainwater covered on the window, and if the wiping frequency of the windshield wiper is further improved, the windshield wiper is easily damaged.

In order to achieve the above object, the present application provides a method for controlling a windshield wiper of a new energy automobile, which is applied to a windshield wiper control system of an automobile, the windshield wiper control system comprising: a windshield wiper controller, a rainfall sensor, a windshield wiper control terminal, a windshield wiper and a central control display screen; the windshield wiper controller is respectively connected with the rainfall sensor, the windshield wiper control terminal, the windshield wiper and the central control display screen; the windshield wiper is configured to wipe a windshield of the automobile;
the method includes:
when the windshield wiper controller is in a first wiping state, if the windshield wiper controller receives a high-speed gear signal sent by the windshield wiper control terminal or receives a rainstorm instruction sent by the central control display screen, the windshield wiper controller entering a rainstorm mode;
when the windshield wiper controller is in a second wiping state, if the windshield wiper controller receives the rainstorm instruction sent by the central control display screen, the windshield wiper controller entering the rainstorm mode;
wherein, the first wiping state is a working state that the windshield wiper controller controls the windshield wiper to wipe a specified area of the automobile window according to a maximum value signal, the maximum value signal is a frequency maximum value in a wiping frequency interval, and the wiping frequency interval is a frequency interval used by the rainfall sensor to determine the wiping frequency of the windshield wiper according to rainfall of an environment in which the automobile is located;
the second wiping state is a working state in which the windshield wiper controller controls the windshield wiper according to the high-speed gear signal to wipe a specified area of the windshield of the automobile; the high-speed gear signal is sent by the windshield wiper control terminal and is used to instruct the windshield wiper to wipe the windshield of the automobile at a high-speed frequency; and
the rainstorm mode is used for instructing the windshield wiper controller to control the windshield wiper to wipe a critical area of the windshield of the automobile at a safety frequency, the value of the safety frequency is greater than or equal to the high-speed frequency, and a range of the critical area is less than the specified area.

Further, the windshield wiper controller is in the first wiping state includes:
if the windshield wiper controller detects that the rainfall sensor is turned on, the windshield wiper controller sending an automatic gear command to the rainfall sensor;
the rainfall sensor detecting rainfall of the environment where the automobile is located according to the automatic gear command and generating a frequency command based on the rainfall, and the rainfall sensor sending the frequency command to the windshield wiper controller; and
the windshield wiper controller controlling the windshield wiper to wipe the windshield of the automobile according to the frequency command, and determining that the windshield wiper controller is in the first wiping state.

Further, the windshield wiper controller is in the second wiping state includes:
if the windshield wiper controller does not detect that the rainfall sensor is turned on and detects a gear signal sent by the windshield wiper control terminal, the windshield wiper controller controlling the windshield wiper to wipe the windshield according to a frequency in the gear signal;
wherein, the gear signal is one of a high-speed gear signal and at least one non-high-speed gear signal; the non-high-speed gear signal is command information sent by the windshield wiper control terminal and used for instructing the windshield wiper to wipe the windshield of the automobile at a non-high-speed frequency; and the valve of the non-high-speed frequency is less than a high-speed frequency.

Further, the windshield wiper control system further includes an automobile speed sensor and a temperature sensor; the automobile speed sensor is connected to the windshield wiper controller, and the automobile speed sensor is configured to detect an automobile speed of the automobile; and the temperature sensor is connected to the windshield wiper controller, and the temperature sensor is configured to detect a temperature of the windshield wiper.

Before the windshield wiper controller enters the rainstorm mode, the method further includes:
the windshield wiper controller triggering the automobile speed sensor to feed back a current automobile speed of the automobile;
the windshield wiper controller triggering the temperature sensor to feed back a current temperature of the windshield wiper if it is determined that the current automobile speed does not exceed a preset automobile speed threshold; and
if the windshield wiper controller determines that the current temperature does not exceed a preset temperature threshold, the windshield wiper controller entering the rainstorm mode.

Further, wherein the windshield wiper control system further includes: a configuration module, which is connected to the windshield wiper controller;
the windshield wiper controller enters the rainstorm mode includes:
the windshield wiper controller sets a rainstorm frequency as the safety frequency if the rainstorm frequency parameter is extracted from the configuration module, the rainstorm frequency parameter being greater than or equal to the frequency maximum value;
the windshield wiper controller sets a maximum frequency value as the safety frequency if no rainstorm frequency parameter is extracted from the configuration module; and
the windshield wiper controller extracts an upper angle parameter and a lower angle parameter from the configuration module, and controlling the windshield wiper to wipe the windshield of the automobile with the safety frequency by taking the lower angle parameter as a bottom dead center and taking the upper angle parameter as a top dead center, the top dead center and the bottom dead center being in the critical area on the windshield of the automobile.

Further, after the windshield wiper controller enters the rainstorm mode, the method further includes:
if the windshield wiper controller determines that the current automobile speed exceeds the preset automobile speed threshold and/or if the windshield wiper controller determines that the rainfall of the environment where the automobile is located is lower than a preset rainfall threshold, stops the rainstorm mode; and/or
if the windshield wiper controller determines that the current temperature exceeds the preset temperature threshold, stops the rainstorm mode; and/or
the windshield wiper control system further including a fault detection module; wherein the fault detection module is connected with the windshield wiper controller, and the fault detection module is used for detecting whether the automobile and the windshield wiper are faulty or not; and after the windshield wiper controller enters the rainstorm mode, the method further includes: if the windshield wiper controller receives a fault signal sent by the fault detection module, stops the rainstorm mode by the windshield wiper controller, the fault signal representing that the automobile and/or the windshield wiper are faulty.

Further, after the windshield wiper controller stops the rainstorm mode, the method further includes:
if it is determined that the windshield wiper controller is in the first wiping state before entering the rainstorm mode, the windshield wiper controller enters the first wiping state again; and
if it is determined that the windshield wiper controller is in the second wiping state before entering the rainstorm mode, the windshield wiper controller entering the second wiping state again.

Further, after the windshield wiper controller enters the rainstorm mode, the method further includes:
if the windshield wiper controller receives a central control conventional signal sent by the central control display screen, the windshield wiper controller stopping the rainstorm mode, and controlling the windshield wiper to wipe the windshield of the automobile according to a central control conventional frequency in the central control conventional signal, the central control conventional signal is used to instruct the windshield wiper controller to control the windshield wiper, and wipe the specified area at a frequency less than the maximum frequency value; and the central control conventional frequency is generated by the central control display screen, and a value of the central control conventional frequency is less than a frequency value of the maximum frequency value;
if the windshield wiper controller receives a terminal normal signal sent by the windshield wiper control terminal, the windshield wiper controller stopping the rainstorm mode, and controlling the windshield wiper to wipe the windshield of the automobile according to a terminal normal frequency in the terminal normal signal, wherein the terminal normal signal is used to instruct the windshield wiper controller to control the windshield wiper to wipe the specified area at a frequency less than the maximum frequency value, and the terminal normal frequency is generated by the windshield wiper control terminal and has a value less than a frequency value of the maximum frequency value.

Further, an electronic equipment, includes a memory, a processor, and a computer program stored in the memory and executable on the processor, wherein when the processor of the electronic equipment executes the computer program, steps of the method for controlling the windshield wiper of the new energy automobile according to above methods are implemented.

Further, a computer-readable storage medium, the medium has a computer program stored thereon, wherein when the computer program stored in the computer-readable storage medium is executed by the processor, steps of the windshield wiper control method for the new energy automobile according to above methods are implemented.

The application provides a new energy automobile windshield wiper control method, electronic equipment and storage medium, and the method includes the following steps: by setting a rainstorm mode, the windshield wiper controller can control the windshield wiper to wipe the automobile window at a safety frequency in a critical area, namely: the high-frequency wiping is carried out in the smaller wiping area, so that the high-frequency scraping can be carried out aiming at the critical area, the rainwater on the automobile window can be wiped in time, the visual field of a driver is ensured to be clear, and the occurrence of safety accidents is avoided; and the range of the wiper on the window is limited, so that the stroke of the wiper under high-frequency wiping is shortened, and the damage risk of the wiper is further reduced.

### BRIEF DESCRIPTION OF THE DRAWINGS

FIG. 1 is a structural schematic block diagram of a windshield wiper control system according to the present disclosure.

FIG. 2 is a flowchart of a windshield wiper control method for a new energy automobile according to the present disclosure.

FIG. 3 is a schematic diagram of a hardware structure of an electronic equipment according to the present disclosure.

### DETAILED DESCRIPTION OF THE EMBODIMENTS

In order to make the objects, technical solutions and advantages of the present disclosure clearer, the present disclosure will be further described in detail below with reference to the accompanying drawings and embodiments. It should be understood that the specific embodiments described herein are merely used to explain the present disclosure, and are not intended to limit the present disclosure. Based on the embodiments of the present disclosure, all other embodiments obtained by those skilled in the art without creative efforts fall within the protection scope of the present disclosure.

### Embodiment 1

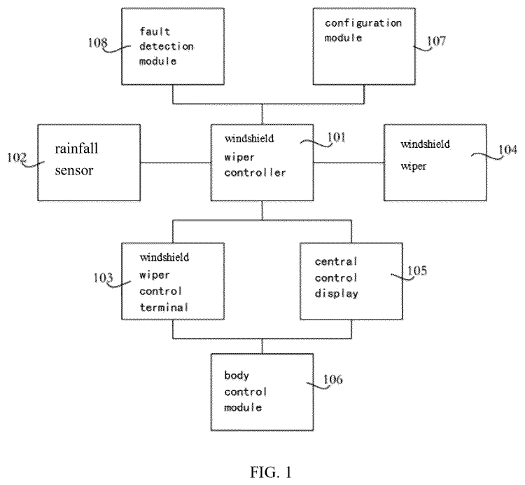

Referring to FIG. 1, a windshield wiper control method for a new energy automobile according to this embodiment is applied to a windshield wiper control system of an automobile, where the windshield wiper control system includes a windshield wiper controller 101, a rainfall sensor 102, a windshield wiper control terminal 103, a windshield wiper 104, and a central control display screen 105; the windshield wiper controller 101 is connected to the rainfall sensor 102, the windshield wiper control terminal 103, the windshield wiper 104, and the central control display screen 105 respectively; and the windshield wiper 104 is configured to wipe a windshield of the automobile.

The method includes:
when the windshield wiper controller 101 is in the first wiping state, if the windshield wiper controller 101 receives a high-speed gear signal sent by the windshield wiper control terminal 103 or receives a rainstorm instruction sent by the central control display screen 105, the windshield wiper controller 101 entering a rainstorm mode; the first wiping state is a working state that the windshield wiper controller 101 controls the windshield wiper 104 to perform wiping on a specified area of the automobile window according to a maximum value signal; the maximum value signal is a frequency maximum value in a wiping frequency interval; and the wiping frequency interval is a frequency interval used by the rainfall sensor 102 to determine a wiping frequency of the windshield wiper 104 according to rainfall in an environment where the automobile is located;
when the windshield wiper controller 101 is in the second wiping state, if the windshield wiper controller 101 receives a rainstorm instruction sent by the central control display screen 105, the windshield wiper controller 101 entering the rainstorm mode, wherein the second wiping state is a working state in which the windshield wiper controller 101 controlling the windshield wiper 104 according to a high-speed gear signal to wipe a specified area of the automobile window; the high-speed gear signal is sent by the windshield wiper control terminal 103 and is used to instruct the windshield wiper 104 to wipe the windshield of the automobile at a high-speed frequency; and the rainstorm mode is used to instruct the windshield wiper controller 101 to control the windshield wiper 104 to wipe a critical area of the automobile window at a safety frequency, a value of the safety frequency is greater than or equal to the high-speed frequency, and a range of the critical area is less than the specified area.

In this embodiment, by setting the rainstorm mode, the windshield wiper controller 101 can control the windshield wiper 104 to wipe the windshield of the automobile at a safety frequency in the critical area, perform high-frequency wiping in a smaller wiping area, which can not only perform high-frequency wiping for the critical area, but also ensure that rainwater on the automobile window can be wiped in time, thereby ensuring that the visual field of the driver is clear and avoiding the occurrence of safety accidents; but also, by limiting the wiping range of the windshield wiper 104 on the windshield of the automobile, the stroke of the windshield wiper 104 under the high-frequency wiping is shortened, thereby reducing the damage risk of the windshield wiper 104.

When the windshield wiper controller 101 is in the first wiping state, if the windshield wiper controller 101 receives the high-speed gear signal sent by the windshield wiper control terminal 103 or receives the rainstorm instruction sent by the central control display screen 105, the windshield wiper controller 101 entering the rainstorm mode, so that the windshield wiper controller 101 enters the rainstorm mode in an automatic wiping scenario (a scenario in which a wiping frequency of the windshield wiper 104 is determined based on rainfall according to the rainfall sensor 102). Once the maximum value of the wiping frequency interval is reached, the driver only needs to operate the windshield wiper control terminal 103 to generate a high-speed gear signal, or generate a rainstorm instruction through the central control display screen 105, so that the windshield wiper controller 101 can enter the rainstorm mode, which provides convenience for the driver to enter the rainstorm mode.

When the windshield wiper controller 101 is in the second wiping state, if the windshield wiper controller 101 receives the rainstorm instruction sent by the central control display screen 105, the windshield wiper controller 101 entering the rainstorm mode, so that the windshield wiper controller 101 enters the rainstorm mode in a manual wiping scenario (a scenario in which the windshield wiper 104 is controlled according to the height signal sent by the windshield wiper control terminal 103). The driver only needs to operate the central control display screen 105 to generate a rainstorm instruction, so that the windshield wiper controller 101 can enter a rainstorm mode, and operation convenience is provided for the driver.

Meanwhile, the central control display screen 105 has the highest priority, so that the rainstorm instruction generated by the central control display screen 105 can enable the windshield wiper controller 101 to enter the rainstorm mode in both the automatic wiping scenario and the manual wiping scenario, thereby ensuring the reliability of entering the rainstorm mode.

In the automatic wiping scenario, the driver can enter the rainstorm mode in combination with the operation of shifting the rainstorm control terminal 103 (i.e., adjusts the rainstorm control terminal 103 to the high-speed gear and generates the high-speed gear signal), so that the driver does not need to operate the central control display screen 105, the operation convenience is further provided for the driver, and the situation that the driver distracts the attention of the driver due to the fact that the driver searches and touches the rainstorm button used for generating the rainstorm instruction on the central control display screen 105 is avoided.

In the manual wiping scenario, the driver needs to trigger the rainstorm button of the central control display screen 105 to generate a rainstorm instruction, so that the windshield wiper controller 101 enters the rainstorm mode, and the driver can only enter the rainstorm mode through the central control display screen 105, without mistakenly causing the windshield wiper controller 101 to enter the rainstorm mode due to other operations performed by the driver (for example, frequently operating the windshield wiper control terminal 103), thereby ensuring that the windshield wiper controller 101 completely operates according to the intention of the driver in the manual wiping scenario, and ensuring reliability in the manual wiping scenario.

In this embodiment, the windshield wiper controller 101 is a device for manipulating and controlling the automobile windshield wiper 104, typically located on a steering wheel or instrument panel next to the automobile driver's seat. The main function of the windshield wiper controller 101 is to start, stop and adjust the operation of the windshield wiper 104 to remove rainwater, snow or other sundries on the windshield, thereby ensuring that the sight of the driver remains clear and improving the driving safety.

In this embodiment, the windshield wiper controller 101 has the following functions: start and stop: by rotating or pushing a switch or button on the windshield wiper controller 101, the driver can start the windshield wiper 104 to start working to remove raindrops or other dirt on the windshield. Operating the switch or button again will stop operation of the windshield wiper 104. Speed regulation: the windshield wiper controller 101 generally allows the driver to adjust the speed of the windshield wiper 104 to accommodate different degrees of precipitation. There are typically multiple speed options, including fast, medium and slow. Rain sensing functionality based on rainfall sensor 102: some modern automobiles are equipped with rain sensing windshield wiper 104 systems that can automatically adjust the speed of windshield wiper 104 based on sensed rain intensity. In this way, the windshield wiper 104 will work automatically when needed without manual operation by the driver. Cleaning function: the windshield wiper controller 101 also typically includes a cleaning water spray function that allows the driver to spray cleaning fluid onto the windshield using a water spray to help clean up more stubborn dirt. The specific design and function of the windshield wiper controller 101 may vary from car manufacturer and car type, but in general, they are key car safety devices, helping to keep the driver's line of sight clear, reducing the driving risk in rainy days or severe weather.

A windshield wiper control lever is used as the windshield wiper control terminal 103, and the windshield wiper control lever is a device for operating and controlling the automobile windshield wiper 104, and is usually located on a steering wheel or an instrument panel near a driver's seat of the automobile. The lever is typically a rod, and the driver can control the operation of the windshield wiper 104 by rotating, pushing or pressing a switch or button thereon. These operations include start, stop, speed adjustment, and water spray cleaning functions.

In this embodiment, the windshield wiper operating lever functions include: start and stop: by rotating or pushing a switch or button on the operating lever, the driver can start the windshield wiper 104 to start working, so as to remove raindrops or other dirt on the windshield. Operating the switch or button again will stop operation of the windshield wiper 104. Speed regulation: the windshield wiper lever typically has multiple speed settings, allowing the driver to adjust the speed of the windshield wiper 104 to accommodate different degrees of precipitation. Speed settings typically include fast, medium, and slow. Cleaning function: a button or switch is usually provided on the operating rod for activating the water spraying cleaning function of the windshield wiper 104. Pressing this button will spray cleaning fluid onto the windshield, helping to remove more stubborn dirt. The specific design and function of the windshield wiper control rod may vary from automobile manufacturer to automobile model, but usually have the above functions to help the driver keep clear sight in rainy days or severe weather, thereby improving driving safety.

The rainfall sensor 102 is referred to as a rain light sensor (RLS), which monitors the amount of rain on the windshield, monitors the lighting condition, and provides a control signal for the electrical system through circuit calculation.

The central control display screen 105 and the windshield wiper control terminal 103 are connected with the automobile body control module 106; the central control display screen 105 generates a rainstorm instruction through the automobile body control module 106 according to the rainstorm key clicked by the driver on the central control display screen 105; and the windshield wiper control terminal 103 generates an automatic gear signal and a gear signal through the automobile body control module 106 according to the automatic gear operation, the high-speed gear signal and the non-high-speed gear signal of the driver on the windshield wiper control terminal 103, wherein the gear signal includes the high-speed gear signal and the non-high-speed gear signal. The automobile body control module 106 is a BCM, and is fully referred to as a Body Control Module, which is one of key components in an electronic control system of the automobile, and is mainly responsible for controlling electrical device of various systems of the automobile body, such as lights, independent heaters, windshield wipers, doors and windshields, and can also communicate with a communication network in the automobile, such as controller area network (CAN) communication and code spectrum, to complete various sensing and control functions.

The windshield wiper 104 is configured to remove rainwater, snow, and other sundries on the windshield glass to ensure clear sight of a driver and improve driving safety. The windshield wiper 104 is typically comprised of a squeegee or brush that is mounted on the windshield and moved by a motor or manual operation to wipe or wipe rain or other debris. In severe weather conditions, the windshield wipers 104 are very important because they can help the driver keep good sight, reducing the risk of accidents. In addition to front windshield wipers 104, some automobiles are equipped with rear windshield wipers 104 for cleaning rain and dirt on a rear windshield.

### Embodiment 2

This embodiment is a specific application scenario of the first embodiment, and the method provided by the present disclosure can be described more clearly and specifically through this embodiment.

The method provided in this embodiment is specifically described by using an embodiment in which a windshield of the automobile is wiped in the rainstorm mode. It should be noted that this embodiment is merely exemplary, and does not limit the protection scope of the embodiments of the present disclosure.

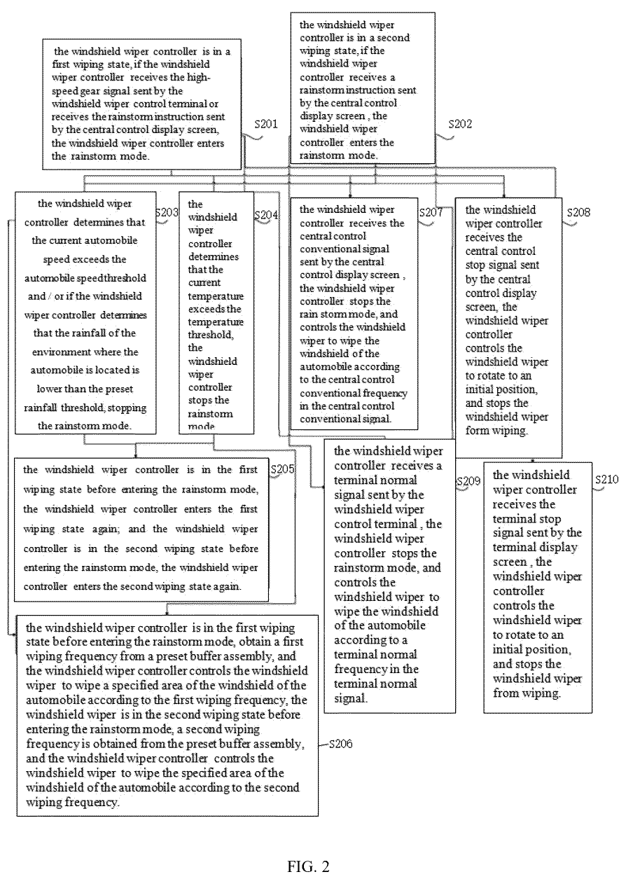

Referring to FIG. 1 and FIG. 2, the present application provides a windshield wiper control method for a new energy automobile, and by setting the rainstorm mode, the windshield wiper controller can control a windshield wiper to wipe a windshield of the automobile at a safety frequency in the critical area, a high-frequency windshield wiper is performed in a relatively small windshield wiper area, so that high-frequency windshield wiper can be performed for the critical area, it is ensured that rainwater on the automobile window can be wiped in time, thereby ensuring that a visual field of the driver is clear, and avoiding a safety accident; and by limiting a windshield wiper range on the automobile window, a stroke of the windshield wiper under the high-frequency windshield wiper is shortened, thereby reducing a damage risk of the windshield wiper.

The disclosure provides a windshield wiper control method for a new energy automobile, which is applied to a windshield wiper control system of the automobile, the windshield wiper control system includes the windshield wiper controller 101, the rainfall sensor 102, the windshield wiper control terminal 103, the windshield wiper 104 and the central control display screen 105; the windshield wiper controller 101 is respectively connected with the rainfall sensor 102, the windshield wiper control terminal 103, the windshield wiper 104 and the central control display screen 105; and the windshield wiper 104 is used for wiping the windshield of the automobile;

The method includes:

S201: when the windshield wiper controller 101 is in the first wiping state, if the windshield wiper controller 101 receives the high-speed gear signal sent by the windshield wiper control terminal 103 or receives the rainstorm instruction sent by the central control display screen 105, the windshield wiper controller 101 entering the rainstorm mode, where the first wiping state is a working state in which the windshield wiper controller 101 controlling the windshield wiper 104 to perform wiping on the specified area of the windshield of the automobile according to a maximum value signal, the maximum value signal is a frequency maximum value in a wiping frequency interval, and the wiping frequency interval is a frequency interval used by the rainfall sensor 102 to determine the wiping frequency of the windshield wiper 104 according to the rainfall of the environment where the automobile is located.

S202: when the windshield wiper controller 101 is in a second wiping state, if the windshield wiper controller 101 receives a rainstorm instruction sent by the central control display screen 105, the windshield wiper controller 101 entering the rainstorm mode, where the second wiping state is a working state in which the windshield wiper controller 101 controlling the windshield wiper 104 according to a high-speed signal to wipe a specified area of a windshield of the automobile, the high-speed signal is sent by the windshield wiper control terminal 103 and is used to instruct the windshield wiper 104 to wipe the windshield of the automobile at a high-speed frequency, and the rainstorm mode is used to instruct the windshield wiper controller 101 to control the windshield wiper 104 to wipe a critical area of the windshield of the automobile at a safety frequency, a value of the safety frequency is greater than or equal to the high-speed frequency, and a range of the critical area is less than the specified area.

Optionally, when the windshield wiper controller 101 is in the second wiping state, if the windshield wiper controller 101 receives a rainstorm instruction sent by an automobile front camera, the windshield wiper controller 101 entering a rainstorm mode, where the automobile front camera generates a rainstorm signal if detecting that a light transmittance of a windshield of the new energy automobile is lower than a preset light transmittance threshold, and the light transmittance is an intensity of light from an external light ray entering the new energy automobile through the windshield. In this embodiment, the rain has a serious influence on the sight line of the driver, and the windshield is provided with a windshield wiper, but since the light transmittance is reduced due to rainwater, the visible distance is greatly shortened, the visibility is greatly reduced, and great difficulty is brought to correctly observing, judging incoming automobiles and pedestrians, and correctly selecting a driving route; therefore, when the front camera of the automobile detects that the light transmittance of the windshield is reduced to the light transmittance threshold, the rainstorm instruction is sent to the windshield wiper controller 101, so that the windshield wiper controller 101 enters the rainstorm mode to ensure that the camera is clear, thereby protecting the safety of pedestrians and automobiles.

S203: if the windshield wiper controller 101 determines that the current automobile speed exceeds the automobile speed threshold and/or if the windshield wiper controller 101 determines that the rainfall of the environment where the automobile is located is lower than the preset rainfall threshold, stopping the rainstorm mode.

S204: if the windshield wiper controller 101 determines that the current temperature exceeds the temperature threshold, the windshield wiper controller 101 stopping the rainstorm mode.

S205: if it is determined that the windshield wiper controller 101 is in the first wiping state before entering the rainstorm mode, the windshield wiper controller 101 entering the first wiping state again; and if it is determined that the windshield wiper controller 101 is in the second wiping state before entering the rainstorm mode, the windshield wiper controller 101 entering the second wiping state again.

S206: if it is determined that the windshield wiper controller 101 is in the first wiping state before entering the rainstorm mode, obtain a first wiping frequency from a preset buffer assembly, and the windshield wiper controller 101 controlling the windshield wiper 104 to wipe a specified area of the windshield of the automobile according to the first wiping frequency, where the first wiping frequency is less than a frequency maximum value represented by a maximum value signal; for example, the frequency maximum value is 60 cpm, the first wiping frequency is 40 cpm, and cpm is an abbreviation of count per minute. Hz refers to the count per second, so the conversion relationship is 1 cpm=( 1/60) Hz, or 1 Hz=60 cpm. Frequency, which is the number of times of completing the periodic change in unit time, is a quantity describing the frequent degree of periodic motion, and is usually represented by a symbol f or v, the unit is one second, and the symbol is s⁻¹.

If it is determined that the windshield wiper 101 is in the second wiping state before entering the rainstorm mode, a second wiping frequency is obtained from the preset buffer assembly, and the windshield wiper controller 101 controls the windshield wiper 104 to wipe the specified area of the windshield of the automobile according to the second wiping frequency, where the second wiping frequency is less than the high-speed frequency represented by the high-speed gear signal; for example, the high-speed frequency is 70 cpm, and the second wiping frequency is 45 cpm.

S207: if the windshield wiper controller 101 receives the central control conventional signal sent by the central control display screen 105, the windshield wiper controller 101 stopping the rainstorm mode, and controlling the windshield wiper 104 to wipe the windshield of the automobile according to the central control conventional frequency in the central control conventional signal, where the central control conventional signal is used to instruct the windshield wiper controller 101 to control the windshield wiper 104 to wipe the specified area at a frequency less than the maximum frequency, and the central control conventional frequency is generated by the central control display screen 105 and has a value less than the maximum frequency value. Exemplarily, the central control conventional signal is an electrical signal generated by the user by operating a windshield wiper control page on the central control display screen for controlling the windshield wiper, and the user may click a high-grade wiping button, a medium-grade wiping button, a low-grade wiping button, and the like on the central control display screen to generate central control conventional signals with different central control conventional frequencies (a high-grade wiping frequency, a medium-grade wiping frequency, and a low-grade wiping frequency).

S208: if the windshield wiper controller 101 receives the central control stop signal sent by the central control display screen 105, the windshield wiper controller 101 controlling the windshield wiper 104 to rotate to an initial position, and stops the windshield wiper 104 form wiping, where the initial position is a position of the windshield wiper during starting, and is usually a position where a windshield wiper of the windshield wiper is parallel to the bottom edge of the windshield of the automobile.

S209: if the windshield wiper controller 101 receives a terminal normal signal sent by the windshield wiper control terminal 103, the windshield wiper controller 101 stopping the rainstorm mode, and controls the windshield wiper 104 to wipe the windshield of the automobile according to a terminal normal frequency in the terminal normal signal, where the terminal normal signal is used to instruct the windshield wiper controller 101 to control the windshield wiper 104 to wipe the specified area at a frequency less than a frequency maximum, and the terminal normal frequency is generated by the windshield wiper control terminal 103 and has a value less than a frequency value of the frequency maximum. Exemplarily, the terminal conventional signal is an electrical signal generated by the user by operating the position of the control lever of the windshield wiper control terminal and used for controlling the windshield wiper, and the user may click a high-grade wiping gear, a medium-grade wiping gear, a low-grade wiping gear and the like on the terminal display screen by shifting the control lever to generate terminal conventional signals having different terminal conventional frequencies (a high-grade wiping frequency, a medium-grade wiping frequency, and a low-grade wiping frequency).

S210: if the windshield wiper controller 101 receives the terminal stop signal sent by the terminal display screen 105, the windshield wiper controller 101 controlling the windshield wiper 104 to rotate to an initial position, and stopping the windshield wiper 104 from wiping, where the initial position is a position of the windshield wiper during starting, and is usually a position where a windshield wiper of the windshield wiper is parallel to the bottom edge of the windshield. In this embodiment, by setting the rainstorm mode, the windshield wiper controller 101 can control the windshield wiper 104 to wipe the windshield of the automobile at a safety frequency in the critical area, that is, perform high-frequency wiping in a smaller wiping area, which can not only perform high-frequency wiping for the critical area, but also ensure that rainwater on the windshield of the automobile can be wiped in time, thereby ensuring that the visual field of the driver is clear and avoiding the occurrence of safety accidents; but also, by limiting the wiping range of the windshield wiper 104 on the windshield of the automobile, the stroke of the windshield wiper 104 under the high-frequency wiping is shortened, thereby reducing the damage risk of the windshield wiper 104.

When the windshield wiper controller 101 is in the first wiping state, if the windshield wiper controller 101 receives the high-speed gear signal sent by the windshield wiper control terminal 103 or receives the rainstorm instruction sent by the central control display screen 105, the windshield wiper controller 101 entering the rainstorm mode, so that the windshield wiper controller 101 enters the rainstorm mode in an automatic wiping scenario (that is, a scenario in which a wiping frequency of the windshield wiper 104 is determined based on rainfall according to the rainfall sensor 102). Once the maximum value of the wiping frequency interval is reached, the driver only needs to operate the windshield wiper control terminal 103 to generate a high-speed gear signal, or generate a rainstorm instruction through the central control display screen 105, so that the windshield wiper controller 101 can enter the rainstorm mode, which provides convenience for the driver to enter the rainstorm mode.

When the windshield wiper controller 101 is in the second wiping state, if the windshield wiper controller 101 receives the rainstorm instruction sent by the central control display screen 105, the windshield wiper controller 101 entering the rainstorm mode, so that the windshield wiper controller 101 enters the rainstorm mode in a manual wiping scenario (a scenario in which the windshield wiper 104 is controlled according to the height signal sent by the windshield wiper control terminal 103). The driver only needs to operate the central control display screen 105 to generate a rainstorm instruction, so that the windshield wiper controller 101 can enter a rainstorm mode, and operation convenience is provided for the driver.

Meanwhile, the central control display screen 105 has the highest priority, so that the rainstorm instruction generated by the central control display screen 105 can enable the windshield wiper controller 101 to enter the rainstorm mode in both the automatic wiping scenario and the manual wiping scenario, thereby ensuring the reliability of entering the rainstorm mode.

In this embodiment, the windshield wiper controller 101 controls the rotation speed of the motor of the windshield wiper by adjusting the duty ratio of the pulse current output by the power supply in the windshield wiper to the motor according to the frequency maximum value, the high-speed frequency, the central control conventional frequency, the terminal conventional frequency, the first wiping frequency or the second wiping frequency, so as to control the wiping frequency of the windshield wiper to correspond to the frequency maximum value, the high-speed frequency, the central control conventional frequency, the terminal conventional frequency, the first wiping frequency or the second wiping frequency. The duty ratio of the pulse current is adjusted by using a pulse width modulation (PWM) technology, and pulse width modulation is a method for digitally encoding an analog signal level. Through the use of the high-resolution counter, the duty cycle of the square wave is modulated to encode the level of a specific analog signal, thereby adjusting the duty cycle of the current output by the power supply to the motor. In the automatic wiping scenario, the driver can enter the rainstorm mode in combination with the operation of shifting the rainstorm control terminal 103 (i.e., adjusting the rainstorm control terminal 103 to the high-speed gear and generating the high-speed gear signal), so that the driver does not need to operate the central control display screen 105, the operation convenience is further provided for the driver, and the situation that the driver distracts the attention of the driver due to the fact that the driver searches and touches the rainstorm button used for generating the rainstorm instruction on the central control display screen 105 is avoided.

In the manual wiping scenario, the driver needs to trigger the rainstorm button of the central control display screen 105 to generate a rainstorm instruction, so that the windshield wiper controller 101 enters the rainstorm mode, and the driver can only enter the rainstorm mode through the central control display screen 105, without mistakenly causing the windshield wiper controller 101 to enter the rainstorm mode due to other operations performed by the driver (for example, frequently operating the windshield wiper control terminal 103), thereby ensuring that the windshield wiper controller 101 completely operates according to the intention of the driver in the manual wiping scenario, and ensuring reliability in the manual wiping scenario.

In this embodiment, the windshield wiper controller 101 is a device for manipulating and controlling the automobile windshield wiper 104, typically located on a steering wheel or instrument panel next to the automobile driver's seat. The main function of the windshield wiper controller 101 is to start, stop and adjust the operation of the windshield wiper 104 to remove rainwater, snow or other sundries on the windshield, thereby ensuring that the sight of the driver remains clear and improving the driving safety.

In this embodiment, the windshield wiper controller 101 has the following functions: start and stop: by rotating or pushing a switch or button on the windshield wiper controller 101, the driver can start the windshield wiper 104 to start working to remove raindrops or other dirt on the windshield. Operating the switch or button again will stop operation of the windshield wiper 104. speed regulation: The windshield wiper controller 101 generally allows the driver to adjust the speed of the windshield wiper 104 to accommodate different degrees of precipitation. There are typically multiple speed options, including fast, medium and slow. Rain sensing functionality based on rainfall sensor 102: Some modern automobiles are equipped with rain sensing windshield wiper 104 systems that can automatically adjust the speed of windshield wiper 104 based on sensed rain intensity. In this way, the windshield wiper 104 will work automatically when needed without manual operation by the driver. Cleaning function: the windshield wiper controller 101 also typically includes a cleaning water spray function that allows the driver to spray cleaning fluid onto the windshield using a water spray to help clean up more stubborn dirt. The specific design and function of the windshield wiper controller 101 may vary from car manufacturer and car type, but in general, they are key car safety devices, helping to keep the driver's line of sight clear, reducing the driving risk in rainy days or severe weather.

A windshield wiper control lever is used as the windshield wiper control terminal 103, and the windshield wiper control lever is a device for operating and controlling the automobile windshield wiper 104, and is usually located on a steering wheel or an instrument panel near a driver's seat of the automobile. The lever is typically a rod, and the driver can control the operation of the windshield wiper 104 by rotating, pushing or pressing a switch or button thereon. These operations include start, stop, speed adjustment, and water spray cleaning function.

In this embodiment, the windshield wiper operating lever functions include: start and stop: by rotating or pushing a switch or button on the operating lever, the driver can start the windshield wiper 104 to start working, so as to remove raindrops or other dirt on the windshield. Operating the switch or button again will stop operation of the windshield wiper 104. Speed Regulation: The windshield wiper lever typically has multiple speed settings, allowing the driver to adjust the speed of the windshield wiper 104 to accommodate different degrees of precipitation. Speed settings typically include fast, medium, and slow. Cleaning function: a button or switch is usually provided on the operating rod for activating the water spraying cleaning function of the windshield wiper 104. Pressing this button will spray cleaning fluid onto the windshield, helping to remove more stubborn dirt. The specific design and function of the windshield wiper control rod may vary from automobile manufacturer to automobile model, but usually have the above functions to help the driver keep clear sight in rainy days or severe weather, thereby improving driving safety.

The rainfall sensor 102 is referred to as a rain light sensor (RLS), which monitors the amount of rain on the windshield, monitors the lighting condition, and provides a control signal for the electrical system through circuit calculation.

The central control display screen 105 and the windshield wiper control terminal 103 are connected with the automobile body control module 106; the central control display screen 105 generates a rainstorm instruction through the automobile body control module 106 according to the rainstorm key clicked by the driver on the central control display screen 105; and the windshield wiper control terminal 103 generates an automatic gear signal and a gear signal through the automobile body control module 106 according to the automatic gear operation, the high-speed gear signal and the non-high-speed gear signal of the driver on the windshield wiper control terminal 103, wherein the gear signal includes the high-speed gear signal and the non-high-speed gear signal. The automobile body control module 106 is a BCM, and is fully referred to as a Body Control Module, which is one of key components in an electronic control system of the automobile, and is mainly responsible for controlling electrical device of various systems of the automobile body, such as lights, independent heaters, windshield wipers, doors and windshields, and can also communicate with a communication network in the automobile, such as CAN communication and code spectrum, to complete various sensing and control functions.

The windshield wiper 104 is configured to remove rainwater, snow, and other sundries on the windshield glass to ensure clear sight of a driver and improve driving safety. The windshield wiper 104 is typically comprised of a squeegee or brush that is mounted on the windshield and moved by a motor or manual operation to wipe or wipe rain or other debris. In severe weather conditions, the windshield wipers 104 are very important because they can help the driver keep good sight, reducing the risk of accidents. In addition to front windshield wipers 104, some automobiles are equipped with rear windshield wipers 104 for cleaning rain and dirt on the rear windshield.

If it is detected by the automobile speed sensor that the current automobile speed of the automobile exceeds the automobile speed threshold and/or if it is determined that the rainfall of the environment in which the automobile is located is lower than the preset rainfall threshold, the rainfall of the environment indicates that the automobile can flush rainwater on the windshield of the automobile at the current speed.

If the temperature sensor detects that the current temperature of the windshield wiper 104 exceeds the temperature threshold, the rainfall of the environment indicates that the current temperature of the windshield wiper 104 is relatively high, and in order to prevent the windshield wiper 104 from being damaged, the rainstorm mode is stopped to ensure the safety of the windshield wiper 104.

If the windshield wiper controller 101 receives the central control conventional signal sent by the central control display screen 105, it indicates that the driver wishes to exit the rainstorm mode through the central control display screen 105, and therefore, the windshield wiper controller 101 stops the rainstorm mode, to ensure reliability of exiting the rainstorm mode.

After exiting the rainstorm mode, the automobile is likely to further need to be wiped, and in order to ensure that the sight line of the driver is still not interfered after exiting the rainstorm mode, in this embodiment, the windshield wiper controller 101 is instructed by the central control conventional signal to control the windshield wiper 104, and the windshield of the automobile is wiped at a frequency less than the maximum frequency.

In some cases, when the driver drives at a high speed, it is inconvenient to operate the central control display screen 105, and the driver may operate the windshield wiper control terminal 103 to generate a terminal conventional signal, so that the windshield wiper controller 101 exits the rainstorm mode; in order to ensure that the sight line of the driver is still not interfered after exiting the rainstorm mode, in this embodiment, the windshield wiper controller 101 is instructed to control the windshield wiper 104 through the terminal conventional signal, and the windshield is wiped at a frequency less than the maximum frequency.

In a preferred embodiment, the windshield wiper controller 101 is in the first wiping state, including:
if the windshield wiper controller 101 detects that the rainfall sensor 102 is turned on, the windshield wiper controller 101 sending an automatic gear command to the rainfall sensor 102;
the rainfall sensor 102 detecting rainfall of the environment where the automobile is located according to the automatic gear command, and generating a frequency command according to the rainfall, and the rainfall sensor 102 sending the frequency command to the windshield wiper controller 101;
the windshield wiper controller 101 controlling the windshield wiper 104 to wipe the windshield of the automobile according to the frequency command, and determining that the windshield wiper controller 101 is in the first windshield wiper state.

In this embodiment, the driver operates the windshield wiper control terminal 103 to the automatic gear, so that the rainfall sensor 102 is turned on; if the windshield wiper controller 101 detects that the rainfall sensor 102 is turned on, the windshield wiper controller 101 will enter the automatic wiping scenario, at this time, the windshield wiper sensor will detect the rainfall of the environment where the automobile is located, generating the wiping frequency at which the windshield wiper 104 should wipe the specified area according to the rainfall, and sending the frequency command recording the wiping frequency to the windshield wiper controller 101, the windshield wiper controller 101 controlling the windshield wiper 104 to wipe the windshield of the automobile according to the wiping frequency, at this time, the windshield wiper controller 101 enters the first wiping state, and the first wiping state is the windshield of the automobile wiping mode in the automatic wiping scenario.

If it is detected by the automobile speed sensor that the current automobile speed of the automobile exceeds the automobile speed threshold and/or if it is determined that the rainfall of the environment where the automobile is located is lower than the preset rainfall threshold, the rainfall of the environment indicates that the automobile can flush rainwater on the windshield of the automobile through the current speed; at this time, if the automobile is in the rainstorm mode again, interference will be caused to the driver, and therefore, the rainstorm mode will be stopped; meanwhile, by setting the rainfall threshold, the rainfall of the environment indicates that if the rainfall of the environment where the automobile is located is smaller than the rainfall threshold, it indicates that the automobile does not need to be kept in the rainstorm mode.

If the temperature sensor detects that the current temperature of the windshield wiper 104 exceeds the temperature threshold, it indicates that the current temperature of the windshield wiper 104 is relatively high, and in order to prevent the windshield wiper 104 from being damaged, the rainstorm mode is stopped to ensure the safety of the windshield wiper 104.

If the windshield wiper controller 101 receives the central control conventional signal sent by the central control display screen 105, it indicates that the driver wishes to exit the rainstorm mode through the central control display screen 105, and therefore, the windshield wiper controller 101 stopping the rainstorm mode, to ensure reliability of exiting the rainstorm mode.

After exiting the rainstorm mode, the automobile is likely to further need to be wiped, and in order to ensure that the sight line of the driver is still not interfered after exiting the rainstorm mode, in this embodiment, the windshield wiper controller 101 is instructed by the central control conventional signal to control the windshield wiper 104, and the windshield of the automobile is wiped at a frequency less than the maximum frequency.

In some cases, when the driver drives at a high speed, it is inconvenient to operate the central control display screen 105, and the driver may operate the windshield wiper control terminal 103 to generate a terminal conventional signal, so that the windshield wiper controller 101 exits the rainstorm mode; in order to ensure that the sight line of the driver is still not interfered after exiting the rainstorm mode, in this embodiment, the windshield wiper controller 101 is instructed to control the windshield wiper 104 through the terminal conventional signal, and the windshield is wiped at a frequency less than the maximum frequency.

If the windshield wiper controller 101 is in the first wiping state before entering the rainstorm mode, the windshield wiper controller 101 will enter the first wiping state again after exiting the rainstorm mode, so that after entering the rainstorm mode from the automatic wiping scenario and exiting the rainstorm mode again, the windshield wiper controller 101 will enter the automatic wiping scenario again to ensure the consistency of the wiping scenario.

If the windshield wiper controller 101 is in the first wiping state before entering the rainstorm mode, after exiting the rainstorm mode, the windshield wiper controller 101 will enter the first wiping state again, so that after entering the rainstorm mode from the manual wiping scenario and exiting the rainstorm mode again, the windshield wiper controller 101 will enter the manual wiping scenario again to ensure consistency of the wiping scenario.

In a preferred embodiment, the windshield wiper controller 101 is in the second wiping state, including:
if the windshield wiper controller 101 does not detect that the rainfall sensor 102 is turned on and detects the gear signal sent by the windshield wiper control terminal 103, the windshield wiper controller 101 controlling the windshield wiper 104 to wipe the windshield of the automobile according to the frequency in the gear signal.

The gear signal is one of a high-speed gear signal and at least one non-high-speed gear signal; the non-high-speed gear signal is command information sent by the windshield wiper control terminal 103 for instructing the windshield wiper 104 to wipe the windshield of the automobile at a non-high-speed frequency; and the valve of non-high-speed frequency is less than the high-speed frequency.

In this embodiment, the driver operates the windshield wiper control terminal 103 to a high-speed gear or a non-high-speed gear, the rainfall sensor 102 is not turned on, if the windshield wiper controller 101 does not detect that the rainfall sensor 102 is turned off, the windshield wiper controller 101 entering a manual wiping scenario, and the windshield wiper controller 101 controls the windshield wiper 104 to wipe according to the gear signal sent by the windshield wiper control terminal 103.

Exemplarily, the high-speed frequency is 60 cpm, and the non-high-speed frequencies include: 50 cpm, 40 cpm, 30 cpm, and 20 cpm; if the frequency of the received gear signal is 60 cpm, it is determined that the received gear signal is a high-speed gear signal; if the frequency of the received gear signal is any one of 50 cpm, 40 cpm, 30 cpm, and 20 cpm, it is determined that the received gear signal is a non-high-speed gear signal.

In a preferred embodiment, the windshield wiper control system further includes an automobile speed sensor and a temperature sensor; the automobile speed sensor is connected with the windshield wiper controller 101, and the automobile speed sensor is configured to detect the automobile speed of the automobile; the temperature sensor is connected with the windshield wiper controller 101, and the temperature sensor is configured to detect the temperature of the windshield wiper 104;

Before the windshield wiper controller 101 enters the rainstorm mode, the method further includes:
the windshield wiper controller 101 triggering the automobile speed sensor to feed back the current automobile speed of the automobile.

If the windshield wiper controller 101 determines that the current automobile speed does not exceed the preset automobile speed threshold, the windshield wiper controller 101 triggering the temperature sensor to feed back the current temperature of the windshield wiper 104.

If the windshield wiper controller 101 determines that the current temperature does not exceed the preset temperature threshold, the windshield wiper controller 101 entering the rainstorm mode.

In this embodiment, when the automobile is in a rainstorm environment and the automobile speed is fast, rainwater on the automobile window may be flushed due to high-speed driving of the automobile, and if the automobile enters a rainstorm mode at this time, the windshield wiper 104 may interfere with the field of view of the driver due to wiping on the critical area; therefore, when the current automobile speed does not exceed the speed threshold, it indicates that the automobile cannot flush the rainwater on the windshield of the automobile through the current speed, and the windshield wiper controller 101 may enter the rainstorm mode; and when the current automobile speed exceeds the speed threshold, it indicates that the automobile can flush the rainwater on the automobile window through the current speed, and the windshield wiper controller 101 does not need to enter the rainstorm mode.

Since the windshield wiper 104 in the rainstorm mode may wipe the automobile window in a high-frequency wiping manner in the critical area, the windshield wiper 104 may have a large operating burden in the rainstorm mode, and in order to avoid burning out due to an excessively high temperature of the windshield wiper 104, the current temperature of the windshield wiper 104 is collected through the temperature sensor, if the current temperature does not exceed the temperature threshold, the windshield wiper controller 101 may directly enter the rainstorm mode, and if the current temperature exceeds the temperature threshold, the windshield wiper controller 101 is rejected from entering the rainstorm mode to protect the windshield wiper 104.

For example, assuming that the temperature threshold is 80° C., if the current temperature is not greater than 80° C., the rainstorm mode may be entered, and if the current temperature exceeds 80° C., the rainstorm mode may not be entered.

In a preferred embodiment, the windshield wiper control system further includes a configuration module 107 connected to the windshield wiper controller 101.

The windshield wiper controller 101 enters a rainstorm mode, including:
if the rainstorm frequency parameter is extracted from the configuration module 107, the windshield wiper controller 101 setting the rainstorm frequency to a safety frequency, where the rainstorm frequency parameter is greater than or equal to a maximum frequency value.

If the rainstorm frequency parameter is not extracted from the configuration module 107, the windshield wiper controller 101 sets the maximum frequency value as the safety frequency.

The windshield wiper controller 101 extracts the upper angle parameter (URP-A) and the lower angle parameter (LRP+A) from the configuration module 107, and controls the lower angle parameter of the windshield wiper 104 to be a bottom dead center, the upper angle parameter is a top dead center, and the windshield is wiped at a safety frequency, where the top dead center and the bottom dead center are in a critical area on the windshield.

In this embodiment, a rainstorm frequency parameter may be set in the configuration module 107, if the windshield wiper controller 101 enters the rainstorm mode, the rainstorm frequency parameter is extracted from the configuration module 107 and set to a safety frequency, and the windshield of the automobile is wiped with the safety frequency; meanwhile, the rainstorm frequency parameter may not be set in the configuration module 107, then the maximum frequency value in the configuration module 107 is used as the safety frequency, and the windshield of the automobile is wiped with the safety frequency, so as to ensure that the wiping frequency of the windshield wiper 104 on the windshield of the automobile is at a high frequency wiping degree.

Meanwhile, the critical area is determined by setting the upper angle parameter and the lower angle parameter, so as to realize customized management of the critical area.

Exemplarily, only the wiping frequency interval [20 cpm, 60 cpm] is recorded in the configuration module 107, then 60 cpm is used as the safety frequency; if not only the wiping frequency interval [20 cpm, 60 cpm] is recorded in the configuration module 107, but also the rainstorm frequency parameter: 70 cpm is recorded, then 70 cpm is used as the safety frequency.

An angle range of the specified area is defined in the configuration module 107, for example, [LRP: 0°, URP: 90° ], where LRP is a bottom dead center of the specified area, and URP is a top dead center of the specified area. Therefore, the windshield wiper controller 101 will control the windshield wiper 104 to be wiped on the windshield at an angle range of 0°-90°, which is a specified area.

The upper angle parameter in the configuration module 107 is: 20°, and the lower angle parameter is: 70°, then the windshield wiper controller 101 will control the windshield wiper 104 to wipe on the windshield of the automobile within an angle range of 20°-70°, and the range of the windshield wiper is a critical area.

In a preferred embodiment, the windshield wiper control system further includes: a fault detection module 108; the fault detection module 108 is connected to the windshield wiper controller 101, and the fault detection module 108 is configured to detect whether a fault occurs in the automobile and the windshield wiper 104.

After the windshield wiper controller 101 enters the rainstorm mode, the method further includes:
if the windshield wiper controller 101 receives the fault signal sent by the fault detection module 108, the windshield wiper controller 101 stopping the rainstorm mode, where the fault signal indicates that the automobile and/or the windshield wiper 104 has a fault.

In this embodiment, if the fault detection module 108 detects that the automobile and/or the windshield wiper 104 has a fault, if the windshield wiper controller 101 continues to be in the rainstorm mode, the automobile and/or the windshield wiper 104 may continue to be damaged, causing the fault of the automobile and/or the windshield wiper 104 to expand.

Therefore, once the fault detection module 108 finds that the automobile and/or the windshield wiper 104 has a fault, the fault detection module 108 exiting the rainstorm mode to avoid expanding the fault range or deepening the fault degree.

The fault detection module 108, commonly referred to as an automobile diagnostic module, is an electronic equipment or software tool for monitoring and detecting automobile systems, engines, and other critical components. These modules are important components of modern automobiles and are intended to identify and record automobile performance issues, faults, and error codes.

The main functions of the fault detection module 108 include: diagnosis: monitoring various systems of the automobile, such as engine, transmission, braking system, exhaust system, etc., to detect any anomalies or faults. Record fault code: when a module detects a problem, it generates an error code, called a fault code, to indicate the nature and location of the problem. These trouble codes may be used by a technician or owner for diagnosis and repair. Real-time data monitoring: the module may generally monitor and record real-time data of the automobile, such as automobile speed, engine temperature, oil pressure, air-fuel ratio, etc., to help diagnose problems and optimize performance. Warning the driver: some fault detection modules 108 may send warning signals to the driver, such as engine fault lights or other warning lights, prompting them that there is a problem requiring repair. Maintenance advice: some advanced automobile diagnostic modules may also provide repair advice, including instructing the owner or technician how to fix a particular issue. These modules typically communicate with the automobile's electronic systems through an automotive diagnostic interface, such as the On-Board Diagnostic II interface. Automotive manufacturers use different standards and protocols to implement these functions, and thus, different make and model automobiles may use different fault detection modules 108. These modules are important for quickly and accurately locating and solving automobile problems, and help improve driving safety and automobile performance.

### Embodiment 3

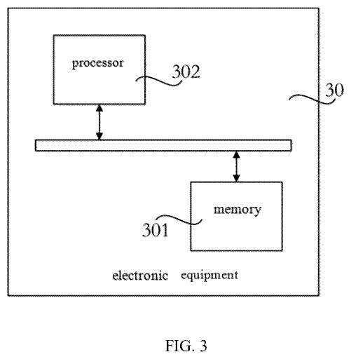

In order to achieve the above object, the present disclosure further provides an electronic equipment 30, the components of the windshield wiper control device of the third embodiment may be dispersed in different electronic equipment, and the electronic equipment 30 may be a smart phone, a tablet computer, a notebook computer, a desktop computer, a rack server, a blade server, a tower server or a rack server (including an independent server or a server cluster composed of a plurality of application servers) executing programs, The electronic equipment of this embodiment at least includes, but is not limited to, a memory 301 and a processor 302 that can be communicatively connected to each other by using a system bus, as shown in FIG. 3. It should be noted that FIG. 3 only shows an electronic equipment having components, but it should be understood that not all shown components need to be implemented, and more or fewer components may be alternatively implemented.

In this embodiment, the memory 301 (the readable storage medium) includes a flash memory, a hard disk, a multimedia card, a card-type memory (for example, a SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, and the like. In some embodiments, the memory 301 may be an internal storage unit of the electronic equipment, such as a hard disk or a memory of the electronic equipment. In some other embodiments, the memory 301 may also be an external storage device of the electronic equipment, for example, a plug-in hard disk, a smart media card (SMC), a secure digital (SD) card, a flash card, and the like equipped on the electronic equipment. Of course, the memory 301 may also include both an internal storage unit and an external storage device of the electronic equipment. In this embodiment, the memory 301 is generally configured to store an operating system and various types of application software installed in an electronic equipment, for example, program codes of the windshield wiper control apparatus in embodiment 3. In addition, the memory 301 may be further configured to temporarily store various types of data that have been output or are to be output.

In some embodiments, the processor 302 may be a central processing unit (CPU), a controller, a microcontroller, a microprocessor, or another data processing chip. The processor 302 is generally used to control the overall operation of the electronic equipment. In this embodiment, the processor 302 is configured to run program code or process data stored in the memory 301, for example, run a windshield wiper control apparatus, to implement the windshield wiper control method for the new energy automobile in embodiment 1 and embodiment 2.

### Embodiment 4

To achieve the foregoing objective, the present embodiment further provides a computer-readable storage medium, for example, a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, a server, an App application mall, and the like, where a computer program is stored, and when the program is executed by the processor 302, corresponding functions are implemented. The computer-readable storage medium of this embodiment is configured to store a computer program for implementing the method for controlling the windshield wiper of the automobile, and when executed by the processor 302, the processor 302 implements the method for controlling the windshield wiper of the automobile according to embodiment 1 and embodiment 2.

The sequence numbers in the foregoing embodiments of the present embodiment are merely for description, and do not represent advantages and disadvantages of the embodiments.

Through the description of the above embodiments, those skilled in the art can clearly understand that the method of the above embodiments can be implemented by means of software plus a necessary universal hardware platform, and certainly can also be implemented by hardware, but the former is a better embodiment in many cases.

The above is only a preferred embodiment of the present disclosure, and is not intended to limit the patent scope of the present disclosure, and any equivalent structure or equivalent flow transformation made by using the specification and accompanying drawings of the present disclosure, or is directly or indirectly applied to other related technical fields, which are included in the patent protection scope of the present disclosure.

What is claimed is:

1. A windshield wiper control method for a new energy automobile, wherein the windshield wiper control method is applied to a windshield wiper control system of the automobile, and the windshield wiper control system comprises a windshield wiper controller, a rainfall sensor, a windshield wiper control terminal, a windshield wiper and a central control display screen; the windshield wiper controller is connected to the rainfall sensor, the windshield wiper control terminal, the windshield wiper and the central control display screen respectively; the windshield wiper is configured to wipe a windshield of the automobile;
the method comprises:
when the windshield wiper controller is in a first wiping state, if the windshield wiper controller receives a high-speed gear signal sent by the windshield wiper control terminal or receives a rainstorm instruction sent by the central control display screen, the windshield wiper controller entering a rainstorm mode;
when the windshield wiper controller is in a second wiping state, if the windshield wiper controller receives the rainstorm instruction sent by the central control display screen, the windshield wiper controller entering the rainstorm mode;
wherein, the first wiping state is a working state in which the windshield wiper controller controls the windshield wiper to wipe a specified area of the windshield of the automobile according to a maximum value signal, the maximum value signal is a frequency maximum value in a wiping frequency interval, and the wiping frequency interval is a frequency interval used by the rainfall sensor to determine a wiping frequency of the windshield wiper according to rainfall of an environment in which the automobile is located;
the second wiping state is a working state in which the windshield wiper controller controls the windshield wiper according to a high-speed gear signal to wipe a specified area of the windshield of the automobile; the high-speed gear signal is sent by the windshield wiper control terminal and is used to instruct the windshield wiper to wipe the windshield of the automobile at a high-speed frequency; and
the rainstorm mode is used to instruct the windshield wiper controller to control the windshield wiper to wipe a critical area of the windshield of the automobile at a safety frequency, a value of the safety frequency is greater than or equal to the high-speed frequency, and a range of the critical area is less than the specified area.

2. The windshield wiper control method according to claim 1, wherein the windshield wiper controller being in a first wiping state comprises:
if the windshield wiper controller detects that the rainfall sensor is turned on, the windshield wiper controller sending an automatic gear command to the rainfall sensor;
the rainfall sensor detecting an amount of rainfall in an environment where the automobile is located in accordance with the automatic gear command and generating a frequency command based on the rainfall, and the rainfall sensor sending the frequency command to the windshield wiper controller; and
the windshield wiper controller controlling the windshield wiper to wipe the windshield of the automobile according to the frequency command, and determining that the windshield wiper controller is in the first windshield wiper state.

3. The windshield wiper control method according to claim 1, wherein the windshield wiper controller being in the second wiping state comprises:
if the windshield wiper controller does not detect that the rainfall sensor is turned on and detects a gear signal sent by the windshield wiper control terminal, the windshield wiper controller controlling the windshield wiper to wipe the windshield according to a frequency in the gear signal;
wherein, the gear signal is one of a high-speed gear signal and at least one non-high-speed gear signal; the non-high-speed gear signal is command information sent by the windshield wiper control terminal and used for instructing the windshield wiper to wipe the windshield of the automobile at a non-high-speed frequency; and the non-high-speed frequency is less than a high-speed frequency.

4. The windshield wiper control method according to claim 1, wherein the windshield wiper control system further comprises an automobile speed sensor and a temperature sensor; the automobile speed sensor is connected to the windshield wiper controller, and the automobile speed sensor is configured to detect an automobile speed of the automobile; and the temperature sensor is connected to the windshield wiper controller, and the temperature sensor is configured to detect a temperature of the windshield wiper;
before the windshield wiper controller enters the rainstorm mode, the method further comprises:
the windshield wiper controller triggering the automobile speed sensor to feed back a current automobile speed of the automobile;
the windshield wiper controller triggering the temperature sensor to feed back a current temperature of the windshield wiper if it is determined that the current automobile speed does not exceed a preset automobile speed threshold; and
if the windshield wiper controller determines that the current temperature does not exceed a preset temperature threshold, the windshield wiper controller entering the rainstorm mode.

5. The windshield wiper control method according to claim 1, wherein the windshield wiper control system further comprises: a configuration module connected to the windshield wiper controller;
the windshield wiper controller entering the rainstorm mode comprises:
the windshield wiper controller setting a rainstorm frequency as the safety frequency if the rainstorm frequency parameter is extracted from the configuration module, the rainstorm frequency parameter being greater than or equal to the frequency maximum value;
the windshield wiper controller setting a maximum frequency value as the safety frequency if no rainstorm frequency parameter is extracted from the configuration module; and
the windshield wiper controller extracting an upper angle parameter and a lower angle parameter from the configuration module, and controlling the windshield wiper to wipe the windshield of the automobile with the safety frequency by taking the lower angle parameter as a bottom dead center and taking the upper angle parameter as a top dead center, the top dead center and the bottom dead center being in the critical area on the windshield of the automobile.

6. The windshield wiper control method according to claim 1, wherein after the windshield wiper controller enters the rainstorm mode, the method further comprises:
if the windshield wiper controller determines that the current automobile speed exceeds the preset automobile speed threshold and/or if the windshield wiper controller determines that the rainfall of the environment where the automobile is located is lower than a preset rainfall threshold, stopping the rainstorm mode; and/or
if the windshield wiper controller determines that the current temperature exceeds the preset temperature threshold, stopping the rainstorm mode; and/or
the windshield wiper control system further comprising a fault detection module; wherein the fault detection module is connected with the windshield wiper controller, and the fault detection module is used for detecting whether the automobile and the windshield wiper are faulty or not; and after the windshield wiper controller enters the rainstorm mode, the method further comprises: if the windshield wiper controller receives a fault signal sent by the fault detection module, stopping the rainstorm mode by the windshield wiper controller, the fault signal representing that the automobile and/or the windshield wiper are faulty.

7. The windshield wiper control method according to claim 6, wherein after the windshield wiper controller stops the rainstorm mode, the method further comprises:
if it is determined that the windshield wiper controller is in the first wiping state before entering the rainstorm mode, the windshield wiper controller entering the first wiping state again; and
if it is determined that the windshield wiper controller is in the second wiping state before entering the rainstorm mode, the windshield wiper controller entering the second wiping state again.

8. The windshield wiper control method according to claim 1, wherein after the windshield wiper controller enters the rainstorm mode, the method further comprises:
if the windshield wiper controller receives a central control conventional signal sent by the central control display screen, the windshield wiper controller stopping the rainstorm mode, and controlling the windshield wiper to wipe the windshield of the automobile according to a central control conventional frequency in the central control conventional signal, wherein the central control conventional signal is used to instruct the windshield wiper controller to control the windshield wiper, and wipe the specified area at a frequency less than the maximum frequency value; and the central control conventional frequency is generated by the central control display screen, and a value of the central control conventional frequency is less than a frequency value of the maximum frequency value;
if the windshield wiper controller receives a terminal normal signal sent by the windshield wiper control terminal, the windshield wiper controller stopping the rainstorm mode, and controlling the windshield wiper to wipe the windshield of the automobile according to a terminal normal frequency in the terminal normal signal, wherein the terminal normal signal is used to instruct the windshield wiper controller to control the windshield wiper to wipe the specified area at a frequency less than the maximum frequency value, and the terminal normal frequency is generated by the windshield wiper control terminal and has a value less than a frequency value of the maximum frequency value.

9. An electronic equipment, comprises a memory, a processor, and a computer program stored in the memory and executable on the processor, wherein when the processor of the electronic equipment executes the computer program, steps of the method for controlling the windshield wiper of the new energy automobile according to claim 1 are implemented.

10. A non-transitory computer-readable storage medium, the medium having a computer program stored thereon, wherein when the computer program stored in the computer-readable storage medium is executed by the processor, steps of the windshield wiper control method for the new energy automobile according to claim 1 are implemented.
